(19) United States
(12) Patent Application Publication
(10) Pub. No.: US 2004/0176933 A1
(43) Pub. Date: Sep. 9, 2004

(54) Symbolic expansion of complex determinants

(75) Inventor: Charles Gordon Hooks, Austin, TX (US)

Correspondence Address: Rudolf O. Siegesmund, Suite 2000, 4627 N. Central Expressway, Dallas, TX, 75205-4017, US

(73) Assignee: International Business Machines Corporation, Armonk, NY (US)

(21) Appl. No.: 10/383,359

(22) Filed: Mar. 6, 2003

(51) Int. Cl. G06F 17/10

(52) U.S. Cl. 703/2

(57) ABSTRACT

A method for reducing the processing time required to compute the expansion of a determinant. The invention systematically examines the determinant for elements that are zero. By systematically determining which elements in the determinant are equal to zero, the invention can determine which terms in the determinant expansion will be zero. The invention can then eliminate these terms from the calculations required to compute the expansion of the determinant. In other words, the invention does not calculate all of the terms of the expanded determinate. Instead, the invention only calculates the terms of the expansion which contain all non-zero terms. By utilizing this methodology, significant processing time is saved because the computer does not perform those calculations which will eventually equal zero.

### FIELD OF THE INVENTION

The present invention is directed in general towards computer programs for mathematical modeling, and specifically to programs that reduce the processing time required for a computer to perform the expansion of a determinant.

### BACKGROUND OF THE INVENTION

Mathematical modeling is an important element in the design and decision making process of many projects. For example, if a government or company is deciding whether to build a dam, a mathematical model of the dam can be constructed to help resolve design questions and estimate costs. After the mathematical model is created, it is typically entered into a computer that calculates the desired output. When input variables such as the height, width, material properties, and costs are entered into a model, the model can compute the output such as the size and total cost of the project. Moreover, the mathematical model is particularly advantageous because the input variables can be changed to formulate new output automatically, without the need to manually repeat the calculations.

Unfortunately, one drawback of mathematical models is that they can be complex and time intensive to create and run. This is particularly true when the input variables are more complex. In some mathematical models, the input variables are not static numbers but dynamic equations or perhaps even another mathematical model. These dynamic equations and models can be in the form of linear equations. The coefficients of the variables of a single linear equation can be described in an array. An example of an array of a linear equation is:

A₁=4x−3y+6z=|4 −3 6|.

Arrays have a single row with multiple columns. A plurality of arrays can be grouped together to form a matrix. A matrix is similar to an array, but with multiple rows and columns. When a matrix has the same number of rows as columns it is said to be square and is called a determinant. Determinants are very useful in solving a plurality of linear equations. A determinant is generally defined as:

$$D = \vert {a}_{ij} \vert = \vert \begin{matrix}{a}_{11} & {a}_{12} & … & {a}_{1 n} \\ {a}_{21} & {a}_{22} & … & {a}_{2 n} \\ ⋮ & & & \\ {a}_{n1} & {a}_{n2} & … & {a}_{nn}\end{matrix} \vert$$

There are n² (n×n) elements in a determinant where n represents the number of rows or columns in the determinant. The elements of a determinant may be real or complex numbers.

The expansion of a determinant is generally calculated according to the equation:

D=Σ(−1)^{h}(a_{1/1}a_{1/2}. . . aₙ₁ₙ)

where the summation is over all possible products of aᵢⱼ, each involving n elements, one and only one from each row and each column. There exist n choices for the first element, (n−1) choices for the second element, and so forth. Thus, for a particular determinant, there are n! (n factorial) terms in the expansion. In each term, the second subscripts j in aᵢⱼ will initially not be in the natural order 1, 2, 3, . . . , n, although all numbers from 1 to n will appear. The value of h is defined as the number of transpositions required to transform the sequence l₁, l₂, . . . , lₙ into the order 1, 2, 3, . . . , n, where a transposition is an interchange of two numbers lₖ and lₘ.

For example, the determinant:

$${D}_{1} = \vert \begin{matrix}{a}_{11} & {a}_{12} \\ {a}_{21} & {a}_{22}\end{matrix} \vert$$

is solved by the equation:

D₁=a₁₁a₂₂−a₁₂a₂₁(2 terms).

Similarly, the determinant:

$${D}_{2} = \vert \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} \vert$$

is solved by the equation:

$$\begin{matrix}{D}_{2} = {a}_{11} \vert \begin{matrix}{a}_{22} & {a}_{23} \\ {a}_{32} & {a}_{33}\end{matrix} \vert - {a}_{12} \vert \begin{matrix}{a}_{21} & {a}_{23} \\ {a}_{31} & {a}_{33}\end{matrix} \vert + {a}_{13} \vert \begin{matrix}{a}_{21} & {a}_{22} \\ {a}_{31} & {a}_{32}\end{matrix} \vert \\ {D}_{2} = {a}_{11} ( {a}_{22} {a}_{33} - {a}_{23} {a}_{32} ) - {a}_{12} ( {a}_{21} {a}_{33} - {a}_{23} {a}_{31} ) + \\ {a}_{13} ( {a}_{21} {a}_{32} - {a}_{22} {a}_{31} ) \\ {D}_{2} = {a}_{11} {a}_{22} {a}_{33} - {a}_{11} {a}_{23} {a}_{32} - {a}_{12} {a}_{21} {a}_{33} + {a}_{12} {a}_{23} {a}_{31} + \\ {a}_{13} {a}_{21} {a}_{32} - {a}_{13} {a}_{22} {a}_{31} ( 6 terms ) .\end{matrix}$$

The calculation of the expansion of the determinant can be further complicated by the fact that an individual element may be of the form:

aᵢⱼ=AₙSₙ+Aₙ₋₁Sₙ₋₁+. . . +A₀S₀

where Aₙ is the coefficient of Sₙ and Sₙ may be a real variable or may be a complex variable with real and imaginary parts in the form (a+bi)ⁿ.

As evidenced by the above examples, the expansion of the determinant becomes increasing complex as the determinant grows in size. In fact, a 10×10 determinant (a determinant with ten rows and ten columns) contains 3,628,800 terms which must be calculated. Mathematical models utilizing determinants of this magnitude and larger are not uncommon and are extremely computationally intensive. This computational intensity is particularly taxing on the hardware components of a computer and results in very long processing times. Therefore, any reduction in the number of required calculations is very beneficial to the model because the intensity of the computations is reduced as well as the overall processing time.

The prior art has addressed the question of alternative methods for solving determinants. U.S. Pat. No. 4,694,455 (the '455 patent) entitled “Decoding Method for Multiple Bit Error Correction BCH Codes” discloses an error detection methodology that utilizes a separate determinant to calculate the expansion of a determinant. U.S. Pat. No. 5,535,140 (the '140 patent) entitled “Polynomial Set Deriving Apparatus and Method” discloses a method for expanding a determinant using a multi-dimensional array. U.S. Pat. No. 6,420,194 B1 (the '194 patent) entitled “Method for Extracting Process Determinant Conditions from a Plurality of Process Signals” discloses a method of expanding the determinant utilizing a series of transform functions. What is needed beyond the '455, '140, and '194 patents is a faster and more efficient method of calculating the expansion for a determinant.

When dealing with determinants, some of the elements in the determinant will be equal to zero. When at least one of the elements of the determinant is zero, then some of the terms of the expansion of the determinant will be zero. Recall the general expansion of a 3×3 determinant, D₂, where:

$${D}_{2} = \vert \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} \vert$$

D₂=a₁₁a₂₂a₃₃−a₁₁a₂₃a₃₂−a₁₂a₂ₗa₃₃+a₁₂a₂₃a₃₁+a₁₃a₂₁a₃₂−a₁₃a₂₂a₃₁.

If the element a₁₁ is equal to zero and the remainder of the elements are non-zero numbers, then the first and second terms of the expansion of the determinant will be equal to zero and the expansion will only have four non-zero terms which must be calculated. If the elements a₁₁ and a₂₃ are zero, then the first, second, and fourth terms of the expansion of the determinant will be equal to zero and the expansion will only have three non-zero terms which must be calculated. By identifying the elements equal to zero in a determinant, the calculation of the expansion terms containing those terms can be avoided because they will always equal zero. Thus, the total number of calculations in expanding the determinant can be reduced.

Consequently, a need exists for a method of calculating the expansion for a determinant in which the zeros in the determinant are identified and zero-containing terms in the expansion are eliminated from consideration, reducing the overall processing time. A need further exists for a method of eliminating unnecessary calculations from those required to compute the expansion for a determinant. The need extends within the art for an improved method for solving a plurality of linear equations containing complex numbers.

### SUMMARY OF THE INVENTION

The present invention, which meets the needs stated above, is a method, implementable on computer software, for reducing the processing time required to compute the expansion of a determinant. The software embodiment of the present invention is comprised of two programs: an implementation program and a determinant expansion program. The implementation program links the determinant expansion program with the database containing the determinant and writes the expansion of the determinant back into the database. The determinant expansion program systematically examines the determinant for elements that are equal to zero. By systematically determining which elements in the determinant are equal to zero, the determinant expansion program can determine which terms in the determinant expansion will contain a zero in their calculation and thus be equal to zero. The determinant expansion program can then eliminate these terms from the calculations required to compute the expansion of the determinant. In other words, the determinant expansion program does not calculate all of the terms of the expanded determinate. Instead, the determinant expansion program only calculates the terms of the expansion which contain all non-zero terms. By utilizing this methodology, significant processing time is saved because the computer does not perform those calculations which will eventually equal zero.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2A and FIG. 2B are flowcharts of the logic of the determinant expansion program of the present invention;

FIG. 3 is a flowchart of the logic of the implementation program of the present invention; and

FIG. 4 is an illustration of the memory within the computer implementing the present invention.

### DETAILED DESCRIPTION OF THE PREFERRED EMBODIMENT

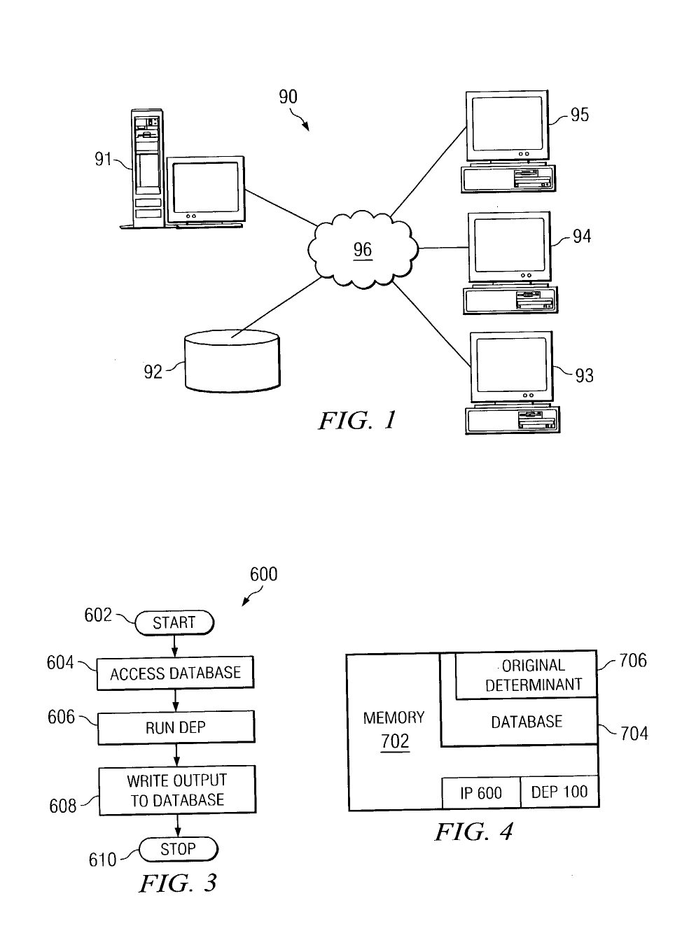

FIG. 1 is an illustration of computer network 90 associated with the present invention. Computer network 90 comprises local machine 95 electrically coupled to network 96. Local machine 95 is electrically coupled to remote machine 94 and remote machine 93 via network 96. Local machine 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of all possible operating systems that may contain the present invention and is not meant as an architectural limitation.

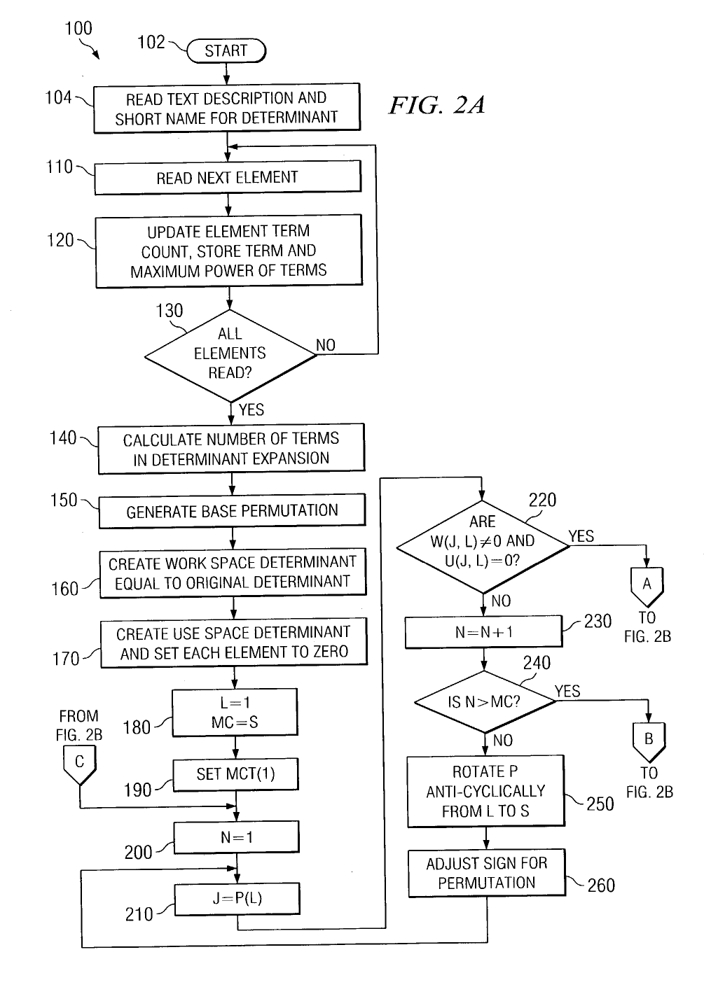

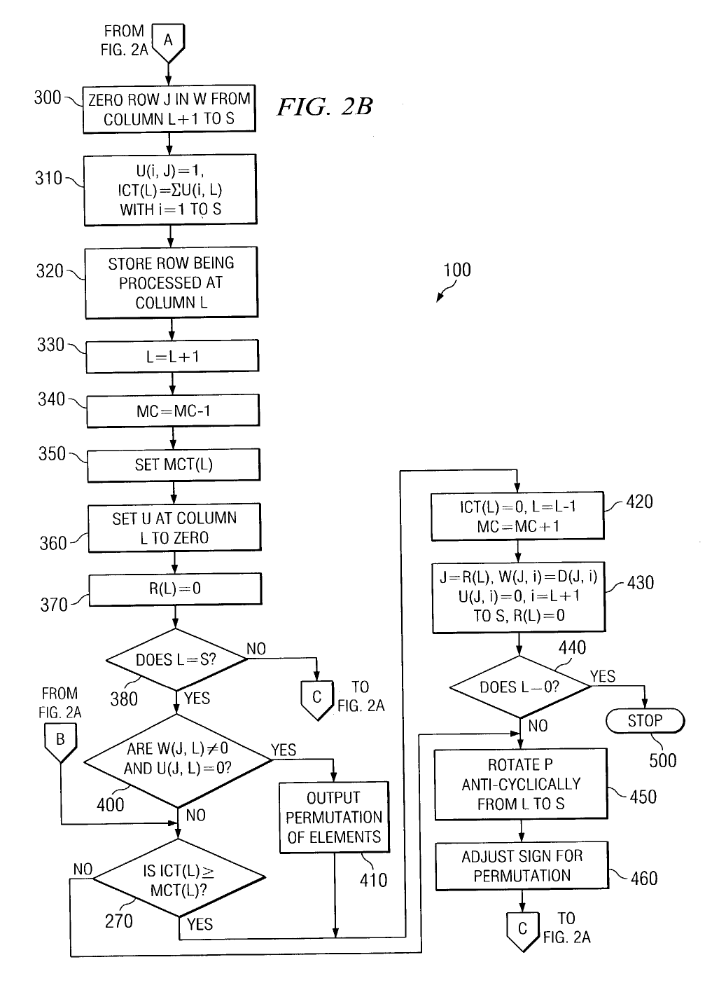

FIGS. 2A and 2B are flowcharts of the logic of the determinant expansion program (DEP) 100 of the present invention. The logic contained in DEP 100 is implementable on software operable on any of the computers depicted in FIG. 1. DEP 100 computes the expansion of a determinant (D). DEP 100 begins (102) and DEP 100 reads a text description and short name for D (104). The short name is a descriptive name of D and the text description is a concise description of the reason for calculating the expansion of D in addition to any other relevant information about D. DEP 100 then reads the first non-zero term for an element of D (110). As DEP 100 reads the terms of an element, DEP 100 determines the number of terms in the element and the maximum power of the terms in the element. DEP 100 then stores the element terms in memory, updates the element term count, and updates the maximum power of the terms (120). The element term count is the number of terms in an element. For example, if the element is 4x, then the element only contains one term. If the element is 4x+5x², then the element contains two terms. It is important to note that whenever an element is equal to zero, the number of terms of that element is also equal to zero. The maximum power of the terms is the highest power of any single term in the element. For example, if the element is 4x, then the maximum power of terms is one. However, if the element is 5x², then the maximum power of the terms is two. DEP 100 then determines if all the elements in D have been read (130). If all of the terms of the elements in D have not been read, DEP 100 returns to step 110 and reads the next term for an element. If at step 130 DEP 100 determines that all of the element data in D has been read, DEP 100 proceeds to step 140.

At step 140, DEP 100 calculates and stores the number of terms in the expansion of D (S) (140). S is equal to the number of rows or columns. DEP 100 then generates a base permutation (P) (150). P is an array that has the same number of terms as the rows or columns of D. Therefore, P will have S terms. P is initially created by the formula P(i)=i, where i=1 to S. DEP 100 then creates a work space determinant (W) and copies the elements of D into W (160). W is the same size as D and is a temporary determinant used by DEP 100 to calculate the expansion of D. The creation of W is represented by the formula W(i,j)=D(i,j). DEP 100 then sets up a use space matching determinant (U) and sets every element in U to zero (170). U is the same size as D. U is another temporary determinant used by DEP 100 to calculate the expansion of D. The creation of U is represented by the formula U(i,j)=0.

DEP 100 uses a number of different internal variables to calculate the expansion of D. Two of these variables are the column (L) and the maximum choices for D (MC). DEP 100 sets L equal to one and MC equal to the size of the expansion of D (180). In other words, L=1 and MC=S to start on column one. Another temporary variable used by DEP 100 is the maximum choices for a particular level L (MCT). DEP 100 sets MCT equal to one (190), represented by the formula MCT(1). Another temporary variable used by DEP 100 is the counter for choices at a particular column (N). DEP 100 sets N equal to one (200), represented by the formula N=1. Another temporary variable DEP 100 uses is an index for P(L). DEP 100 defines P(L) as a row in D corresponding to a column or level in D (210), represented by the formula J=P(L). In other words, for a particular column L, J is the row that DEP 100 analyzes.

DEP 100 then determines if W(J,L) is not equal to zero and U(J,L) is equal to zero (220) indicating a non-zero element has not been used for processing. If both of these tests are true, then DEP 100 proceeds to step 300. If at step 220 one or both of the tests is not true, then DEP 100 increases the counter N (230), represented by the formula N=N+1. DEP 100 then determines if N is greater than MC (240). If N is greater than MC, then DEP 100 proceeds to step 270. If at step 240 N is less than or equal to MC, then DEP 100 rotates P anti-cyclically from L to S (250). Anti-cyclical rotation of P means that each element of the array P from column L to column S is shifted one position to the right and the last element of the array P (i.e. the element in column S) is moved to the first vacant position in the array (i.e. column L). DEP 100 then adjusts the sign of P for the permutation (260). Adjusting the sign of P for the permutation means that DEP 100 analyzes the difference between the number of columns in L and S. If DEP 100 determines that the difference between the number of columns in L and S is odd, then DEP 100 changes the sign of P (i.e. from positive to negative). If DEP 100 determines that the difference between the number of columns of L and S is even, then DEP 100 does not change the sign of P. DEP 100 then returns to step 210.

At step 300 since a good element has been found at level or column L, DEP 100 sets the elements of W equal to zero in row J from column L+1 to column S (300). This action allows DEP 100 to indicate the levels of W that are not usable. In other words, all of the levels to the right of column L in row J of determinant W are not usable, and thus given a zero value since the current row is good and cannot be used again in the current processing. DEP 100 then sets the element i,j in U equal to one and calculates the number of non-zero elements in column L of determinant U (310). These calculations are represented by the formulas U(i,j)=1 and ICT(L)=Σ U(i,L) with i=1 to S. DEP 100 then stores the row being processed at column L (320), represented by the formula R(L)=J which is used to readjust W when the level is decremented. DEP 100 then proceeds to the next column by incrementing L (330), represented by the formula L=L+1. DEP 100 then decrements the maximum number of choices (MC) (340), represented by the formula MC=MC−1. DEP 100 then sets MCT equal to the number of choices at column L (350). DEP 100 then sets all of the elements in column L of determinant U to zero (360). DEP 100 also sets the row being processed at column L to zero (370).

DEP 100 then determines if the current column is the last column (380). If the current column is not the last column, then DEP 100 returns to step 200. If at step 380 the current column is the last column, the DEP 100 determines if determinant W(J,L) is not equal to zero and if determinant U(J,L) is equal to zero (400). If either W(J,L) equals zero or U(J,L) does not equal zero, then DEP 100 proceeds to step 270. If at step 220, both W(J,L) is not equal to zero and U(J,L) is equal to zero, then DEP 100 outputs the permutation of elements (410). In other words, DEP 100 actually calculates the term of the expansion of D in this step because DEP 100 has determined that none of the elements in this term of the expansion of D are zero, and therefore the term of the expansion will not equal zero. DEP 100 then proceeds to step 420.

At step 270, DEP 100 determines if the number of non-zero elements in row L is greater or equal to the maximum number of choices in column L (270). In other words, is ICT(L)≧MCT(L)? If ICT(L)<MCT(L), then DEP 100 proceeds to step 450. If at step 270 ICT(L)≧MCT(L), then DEP proceeds to step 420.

At step 420, DEP 100 moves down a column or level (420). In moving down a column, DEP 100 sets the number of non-zero elements in row L to zero, L is decremented, and MC is incremented. In other words, ICT(L)=0, L=L−1, and MC=MC+1. DEP 100 then resets the temporary variables because the column has changed (430). In resetting the temporary variables, J is set to the row currently being processed at column L, the elements of row J of determinant W are set identical to the elements of row J of D from column L+1 to column S, the elements of row J of the determinant U are set to zero from column L+1 to column S, and the elements of the row at column L is set to zero. In other words, J=R(L), W(J,i)=D(J,i) for i=L+1 to S, U(J,i)=0 for i=L+1 to S, and R(L)=0. DEP 100 then determines if the last column has been analyzed (440). In other words, DEP 100 determines if L=0. If the last column has been analyzed, then DEP 100 ends (500). If the last column has not been analyzed, then DEP 100 rotates P anti-cyclically from L to S (450), as explained in conjunction with step 250. DEP 100 then adjusts the sign of P for the permutation (460), as explained in conjunction with step 260. DEP 100 then returns to step 200.

FIG. 3 is an illustration of the logic of the implementation program (IP) 600 of the present invention. In order for DEP 100 to expand a determinant, DEP 100 must download the determinant from a database and then upload the expanded determinant back to the database. IP 600 links DEP 100 with the database for these purposes. IP 600 begins (602) and accesses the database containing the determinant (604). IP 600 then runs DEP 100 (606), which reads the determinant from the database and generates the expansion of the determinant. IP 600 then records the expansion of the determinant in the database (608) and ends (610).

The internal configuration of a computer, including connection and orientation of the processor, memory and input/output devices, is well known in the art. DEP 100 and IP 600 described herein can be stored within the memory of a computer running DEP 100, IP 600, or within the memory of a separate computer. Alternatively, DEP 100 and IP 600 can be stored in an external storage device such as a removable disk or a CD-ROM. Turning to FIG. 4, memory 702 is illustrative of the memory within any of the above mentioned computers. The memory 702 contains the database 704, within which is the original determinant 706. As part of the present invention, the memory 702 can be configured with DEP 100 and/or IP 600. Further configurations of DEP 100 and IP 600 across various memories are known by persons skilled in the art.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

1. A method comprising:
analyzing a plurality of elements in a determinant to determine which of said elements are equal to zero; and
eliminating a zero-element containing term from the expansion of said determinant.

2. The method of claim 1 wherein the time required to determine said expansion is reduced.

3. The method of claim 1 wherein the number of calculations required to determine said expansion is reduced.

4. The method of claim 1 wherein said analyzing step further comprises:
reading a plurality of elements within a determinant;
calculating the number of terms in the expansion of said determinant;
creating a work space determinant;
creating a use space determinant;
determining if said work space determinant is not equal to zero and said use space determinant is equal to zero;
wherein upon said determination that said work space determinant is not equal to zero and said use space determinant is equal to zero, calculating the term of said expansion.

5. The method of claim 4 further comprising:
rotating said base permutation anti-cyclically; and
adjusting the sign of said rotated base permutation.

6. The method of claim 4 further comprising:
generating a base permutation; and
manipulating said work space determinant and said use space determinant based on said base permutation.

7. The method of claim 4 further comprising:
determining if said work space determinant is not equal to zero and said use space determinant is equal to zero; and
wherein upon said determination that said work space determinant is not equal to zero and said use space determinant is equal to zero, calculating the number of non-zero elements in a particular row.

8. The method of claim 7 further comprising:
determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.

9. A method comprising:
identifying an element within a determinant that is equal to zero; and
reducing the number of terms in an expansion of said determinant by eliminating a zero-element containing term from the expansion of said determinant.

10. The method of claim 9 wherein the time required to determine said expansion is reduced.

11. The method of claim 9 wherein the number of calculations required to determine said expansion is reduced.

12. The method of claim 9 wherein said analyzing step further comprises:
reading a plurality of elements within a determinant;
calculating the number of terms in the expansion of said determinant;
creating a work space determinant;
creating a use space determinant;
determining if said work space determinant is not equal to zero and said use space determinant is equal to zero;
wherein upon said determination that said work space determinant is not equal to zero and said use space determinant is equal to zero, calculating the term of said expansion.

13. The method of claim 12 further comprising:
rotating said base permutation anti-cyclically; and
adjusting the sign of said rotated base permutation.

14. The method of claim 12 further comprising:
generating a base permutation; and
manipulating said work space determinant and said use space determinant based on said base permutation.

15. The method of claim 12 further comprising:
determining if said work space determinant is not equal to zero and said use space determinant is equal to zero; and
wherein upon said determination that said work space determinant is not equal to zero and said use space determinant is equal to zero, calculating the number of non-zero elements in a particular row.

16. The method of claim 15 further comprising:
determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.

17. A method comprising:
reading a plurality of elements within a determinant;
calculating the number of terms in the expansion of said determinant;
creating a work space determinant;
creating a use space determinant;
determining if said work space determinant and said use space determinant are equal to zero;
wherein upon said determination that said work space determinant is not equal to zero and said use space determinant is equal to zero, calculating the term of said expansion.

18. The method of claim 17 further comprising:
rotating said base permutation anti-cyclically; and
adjusting the sign of said rotated base permutation.

19. The method of claim 17 further comprising:
generating a base permutation; and
manipulating said work space determinant and said use space determinant based on said base permutation.

20. The method of claim 17 further comprising:
determining if said work space determinant is not equal to zero and said use space determinant is equal to zero; and
wherein upon said determination that said work space determinant is not equal to zero and said use space determinant is equal to zero, calculating the number of non-zero elements in a particular row.

21. The method of claim 20 further comprising:
determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.

22. A program product operable on a computer, said program product comprising:
a computer-usable medium;
wherein said computer usable medium comprises instructions comprising:
instructions for analyzing a plurality of elements in a determinant to determine which of said elements are equal to zero; and
instructions for eliminating a zero-element containing term from the expansion of said determinant.

23. The program product of claim 22 wherein the time required to determine said expansion is reduced.

24. The program product of claim 22 wherein the number of calculations required to determine said expansion is reduced.

25. The program product of claim 22 wherein said instructions for analyzing step further comprises:
instructions for reading a plurality of elements within a determinant;
instructions for calculating the number of terms in the expansion of said determinant;
instructions for creating a work space determinant;
instructions for creating a use space determinant;
instructions for determining if said work space determinant is not equal to zero and said use space determinant is equal to zero;
wherein upon said determination that said work space determinant is not equal to zero and said use space determinant is equal to zero, calculating the term of said expansion.

26. The program product of claim 25 further comprising:
instructions for rotating said base permutation anti-cyclically; and
instructions for adjusting the sign of said rotated base permutation.

27. The program product of claim 25 further comprising:
instructions for generating a base permutation; and
instructions for manipulating said work space determinant and said use space determinant based on said base permutation.

28. The program product of claim 25 further comprising:
instructions for determining if said work space determinant is not equal to zero and said use space determinant is equal to zero; and
wherein upon said determination that said work space determinant is not equal to zero and said use space determinant is equal to zero, calculating the number of non-zero elements in a particular row.

29. The program product of claim 28 further comprising:
instructions for determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.

30. A program product operable on a computer, said program product comprising:
a computer-usable medium;
wherein said computer usable medium comprises instructions comprising:
instructions for identifying an element within a determinant that is equal to zero; and
instructions for reducing the number of terms in an expansion of said determinant by eliminating a zero-element containing term from the expansion of said determinant.

31. The program product of claim 30 wherein the time required to determine said expansion is reduced.

32. The program product of claim 30 wherein the number of calculations required to determine said expansion is reduced.

33. The program product of claim 30 wherein said instructions for analyzing step further comprises:
instructions for reading a plurality of elements within a determinant;
instructions for calculating the number of terms in the expansion of said determinant;
instructions for creating a work space determinant;
instructions for creating a use space determinant;
instructions for determining if said work space determinant is not equal to zero and said use space determinant is equal to zero;
wherein upon said determination that said work space determinant is not equal to zero and said use space determinant is equal to zero, calculating the term of said expansion.

34. The program product of claim 33 further comprising:
instructions for rotating said base permutation anti-cyclically; and
instructions for adjusting the sign of said rotated base permutation.

35. The program product of claim 33 further comprising:
instructions for generating a base permutation; and
instructions for manipulating said work space determinant and said use space determinant based on said base permutation.

36. The program product of claim 33 further comprising:
instructions for determining if said work space determinant is not equal to zero and said use space determinant is equal to zero; and
wherein upon said determination that said work space determinant is not equal to zero and said use space determinant is equal to zero, calculating the number of non-zero elements in a particular row.

37. The program product of claim 36 further comprising:
instructions for determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.

38. A program product operable on a computer, said program product comprising:
a computer-usable medium;
wherein said computer usable medium comprises instructions comprising:
instructions for reading a plurality of elements within a determinant;
instructions for calculating the number of terms in the expansion of said determinant;
instructions for creating a work space determinant;
instructions for creating a use space determinant;
instructions for determining if said work space determinant is not equal to zero and said use space determinant is equal to zero;
wherein upon said determination that said work space determinant is not equal to zero and said use space determinant is equal to zero, calculating the term of said expansion.

39. The program product of claim 38 further comprising:
instructions for rotating said base permutation anti-cyclically; and
instructions for adjusting the sign of said rotated base permutation.

40. The program product of claim 38 further comprising:
instructions for generating a base permutation; and
instructions for manipulating said work space determinant and said use space determinant based on said base permutation.

41. The program product of claim 38 further comprising:
instructions for determining if said work space determinant is not equal to zero and said use space determinant is equal to zero; and
wherein upon said determination that said work space determinant is not equal to zero and said use space determinant is equal to zero, calculating the number of non-zero elements in a particular row.

42. The program product of claim 41 further comprising:
instructions for determining if the number of non-zero elements in a particular row is greater than or equal to a maximum number of choices for said particular row; and
wherein upon said determination that the number of non-zero elements in a particular row is greater than or equal to a maximum number of choices for said particular row, analyzing the next column in said work space determinant.
